(19) United States
(12) Patent Application Publication
(10) Pub. No.: US 2008/0230611 A1
(43) Pub. Date: Sep. 25, 2008

(54) Variable Laser Beam Focus

(75) Inventors: Randall B. Sprague, Hansville, WA (US); Hakan Urey, Istanbul (TR); Serhan Isikman, Istanbul (TR)

Correspondence Address: MICROVISION, INC., 6222 185TH AVENUE NE, REDMOND, WA, 98052, US

(73) Assignee: Microvision, Inc., Redmond, WA (US)

(21) Appl. No.: 12/134,915

(22) Filed: Jun. 6, 2008

Related U.S. Application Data
(63) Continuation-in-part of application No. 11/704,695, filed on Feb. 9, 2007.
(60) Provisional application No. 60/771,586, filed on Feb. 9, 2006.

(51) Int. Cl. G03B 3/10; G06K 7/10

(52) U.S. Cl. 235/462.22; 235/462.23

(57) ABSTRACT

An imaging device includes a scanning platform coupled to a fixed platform by flexible members. The scanning platform, fixed platform, and flexible members are made of a polymer such as is commonly used for printed circuit boards. The scanning platform has a laser light source, focusing lens, variable focus mechanism, photodetector, and light collection optic mounted thereto. The variable focus mechanism can sweep the outgoing laser light focus to determine the reflection distance. A scan angle may be modified in response. 3D imaging may also be performed.

### RELATED APPLICATIONS

The present application is a Continuation-in-Part (CIP) of U.S. application Ser. No. 11/704,695, entitled “Method and Apparatus for Making and Using 1D and 2D Magnetic Actuators” filed Feb. 9, 2007, which is a non-provisional application of U.S. provisional application Ser. No. 60/771,586, filed on Feb. 9, 2006, both of which are incorporated herein in their entirety by reference for all purposes.

### FIELD

The present invention relates generally to barcode scanners, and more specifically to optical systems within barcode scanners.

### BACKGROUND

Barcode scanners typically have an oscillating scanning mirror to direct a light beam over a scanning angle. Some barcode scanners also have an oscillating light collection mirror that follows the scanning angle and directs collected light to a photodetector. One such barcode scanner is shown in U.S. Pat. No. 7,204,424 awarded to Yavid et al. on Apr. 17, 2007 (the “424” patent).

The device disclosed in the 424 patent is typical of barcode scanners that employ scanning mirrors. The oscillating mirrors are kept very light with low moments of inertia to reduce the energy necessary to make the mirrors oscillate. The light beam source and photodetector circuitry are mounted to a fixed structure, and are aligned with the scanning mirror assembly.

### BRIEF DESCRIPTION OF THE DRAWINGS

FIG. 1 shows a cross section of a light scanning apparatus with variable laser focus;

FIG. 2 shows a perspective view of a light scanning and collection device with light emitting and light collecting systems on a scanning platform;

FIG. 3 shows laser spot size as a function of distance and variable focus;

FIG. 4 shows a cross section of a light scanning and collection device with an integrated optical lens and variable laser focus;

FIG. 5 shows a top view of a scanning platform with a plunging device useful for variable laser focus;

FIG. 6 shows a perspective view of the scanning platform of FIG. 5;

FIGS. 7-9 show imaging devices at various levels of integration;

FIG. 10 shows a biaxial polymer scanning platform;

FIG. 11 shows the operation of a three dimensional imaging device;

FIG. 12 shows a block diagram of an imaging apparatus;

FIG. 13 shows barcode scanner operation with variable focus and a fixed scan angle;

FIG. 14 shows a graph of barcode scanner operation with a variable scan angle; and

FIG. 15 shows a flow chart in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

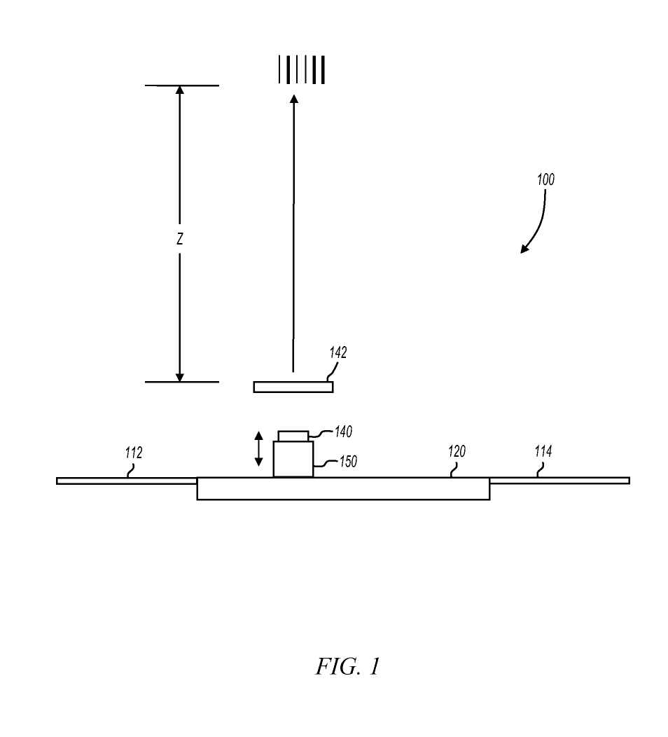

FIG. 1 shows a cross section of a light scanning apparatus with variable laser focus. Apparatus 100 includes scanning platform 120, laser light source 140, variable focus mechanism 150, and lens 142. Laser light source 140 may be any device suitable for creating a laser light beam. For example, laser light source 140 may be a laser diode. Also for example, laser light source 140 may be a vertical cavity surface emitting laser (VCSEL). Lens 142 is an optical device that focuses the laser light from laser light source 140. Laser light source 140 is mounted to variable focus mechanism 150. Variable focus mechanism 150 moves with respect to scanning platform 120 and lens 142. The face of scanning platform 120 is substantially planar and variable focus mechanism 150 operates to move laser light source in a direction having a component orthogonal to the planar face; thereby changing the focus and the location of the “beam waist” of the laser beam.

The “beam waist” of a laser beam is the location along the propagation direction where the beam radius has a minimum. The “waist radius” is the beam radius at this location. In various embodiments of the present invention, a small beam waist (more precisely, a beam waist with small waist radius) is obtained by focusing the laser beam with lens 142. Further, the location of the beam waist along the propagation direction is modified using the variable focus mechanism.

In some embodiments of the present invention, variable laser beam focus is accomplished by moving a laser light source with respect to a lens (as shown in FIG. 1). In other embodiments, variable laser beam focus is accomplished by moving a lens with respect to a laser light source. The manner in which variable laser beam focus is accomplished is not necessarily a limitation of the present invention.

Scanning platform 120 is coupled to flexible members 112 and 114. Flexible members 112 and 114 are also coupled to a separate fixed structure (not shown). As flexible members 112 and 114 flex, they allow scanning platform 120 to move with respect to the fixed structure. In some embodiments, flexible members 112 and 114 undergo a torsional flexure allowing platform 120 to oscillate back and forth on an axis in the plane of the page. Platform 120 is referred to as a “scanning platform” because as the platform oscillates, the laser light scans in at least one dimension. Various embodiments of scanning platforms and flexible members are described further below.

Laser light is reflected off a surface at a “reflection distance.” As used herein, the term “reflection distance” refers to the distance between lens 142 and the reflecting surface. In the example of FIG. 1, the reflecting surface includes a barcode, and the reflection distance is shown as “Z”. In some embodiments, reflected light is gathered using light collection systems (not shown). The light collection systems may include optics and light sensitive electronic devices such as photodiodes. The light collection systems may be co-located with the laser light source on the scanning platform, or they may be located elsewhere. The presence of absence of a light collection system is not necessarily a limitation of the present invention.

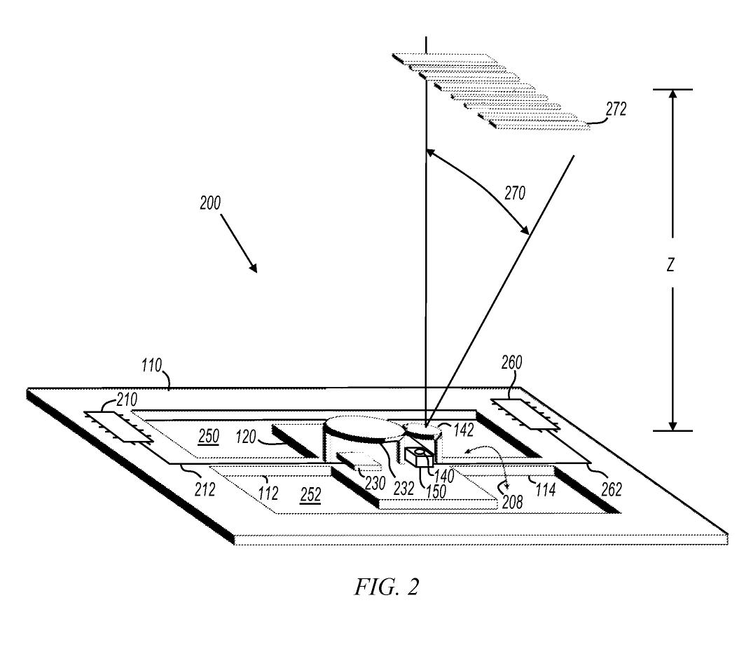

FIG. 2 shows a perspective view of a light scanning and collection device with light emitting and light collecting systems on a scanning platform. Device 200 includes a fixed platform 110 and a scanning platform 120. Scanning platform 120 is coupled to fixed platform 110 by at least one flexible member 112, 114. The long axis of flexible members 112 and 114 form a pivot axis. When flexible members 112 and 114 undergo torsional flexure, they function to allow scanning platform 120 to pivot on the pivot axis while oscillating back and forth as shown by arrow 208. Actuating mechanisms (not shown in FIG. 2) provide the energy necessary to cause scanning platform 120 to oscillate. Various actuating mechanisms are described below with reference to later figures.

In the example embodiments represented by FIG. 2, flexible members 112 and 114 undergo a torsional flexure as scanning platform 120 pivots, although this is not a limitation of the present invention. For example, in some embodiments, flexible members 112 and 114 take on other shapes such as arcs, “S” shapes, or other serpentine shapes. The term “flexure” as used herein refers to any movement of the flexible members that allow scanning platform 120 to have an angular displacement with respect to fixed platform 110. The term “flexure” may also be used to refer to the flexible members themselves.

Scanning platform 120 includes a light emitting system and a light collecting system. The light emitting system includes laser light source 140, focusing lens 142, and variable focus mechanism 150. The light collecting system includes a light sensitive electronic device such as photodiode 230 and optical component 232 to collect light and direct it to the photodiode.

Optical component 232 is shown as a circular lens, although this is not a limitation of the present invention. Any device capable of collecting light may be used. For example, in some embodiments, optical component 232 is a reflective device. Photodiode 230 is mechanically and electrically coupled to scanning platform 120. Laser light source 140 is also electrically and mechanically mounted to scanning platform 120 via focusing mechanism 150. As described above with reference to FIG. 1, lens 142 is a focusing lens that receives laser light from source 140, and provides a converging beam away from scanning platform 120.

The term “scanning assembly” is used herein to refer to scanning platform 120 and any objects affixed thereto. Mounting the light emitting and collection systems on the scanning platform adds mass to the scanning assembly, and this increases the moment of inertia of the scanning assembly. The distance between lens 142 and scanning platform 120 also affects the moment of inertia of the scanning assembly, as does the distance between collection optic 232 and scanning platform 120.

In some embodiments, the scanning platform is made from a relatively stiff material that for a given mechanical resonant frequency accommodates a greater moment of inertia than the lightweight scanning mirrors of the prior art. For example, in some embodiments, a polymer material such as glass-epoxy material may be used. Glass-epoxy materials such as FR4 are commonly used in printed circuit board (PCB) construction.

Polymer materials may be machined to form the fixed platform, scanning platform, and flexible member(s). For example, cut-out areas 250 and 252 may be cut from a solid sheet of FR4. Cutting the cut-out areas from a sheet of polymer material leaves an “island” (scanning platform 120) coupled to the perimeter (fixed platform 110) by flexible members 112 and 114.

The fixed platform, scanning platform, and flexible members may have any thickness. The thickness may or may not be uniform. For example, in some embodiments, flexible members 112 and 114 may be thinner than fixed platform 110 and scanning platform 120. Thickness variations in the polymer material can be used to affect the resonant frequency of the scanning assembly.

Polymer materials may also include metal layers capable of being etched during construction to form signal interconnect. For example, in some embodiments, device 200 may have copper layers on one or two sides. The copper may be etched to provide signal interconnect between the laser light source, the photodiode circuits, and other circuits. Also for example, in some embodiments, the polymer material of device 200 may be formed as a laminate structure with multiple metal layers usable for signal interconnect.

Integrated circuits 210 and 260 are shown mounted to fixed platform 110, and metal traces 212 and 262 are shown coupling the integrated circuits to electrical devices on scanning platform 120. Metal traces 212 and 262 are shown on the top surface of the polymer material, although this is not a limitation of the present invention. For example, metal traces may be on the bottom, or may be on any layer between the top and bottom. Further, any number of metal traces may be included. By utilizing a polymer suitable for use as a PCB material, electrical conductivity may be provided across the flexible members without the need for cabling or wires.

In the various embodiments of the present invention, integrated circuits and other components may be mounted on the fixed platform and the scanning platform in any combination. When mounted to the scanning platform, they become part of the scanning assembly and affect the moment of inertia. When mounted to the fixed platform, they do not affect the moment of inertia of the scanning assembly.

Mounting light emitting and collection systems on the scanning platform provides numerous advantages. Having most components mounted on one assembly simplifies manufacturing and alignment, and also reduces cost. Those skilled in the art will recognize many other advantages that arise from the various embodiments of the present invention.

In operation, the light emitting system emits a laser light beam that is scanned across angle 270 as scanning platform 120 oscillates. The optical characteristics of lens 142 as well as the distance between lens 142 and laser beam source 140 cause the laser beam to be focused at a particular reflection distance “Z”, referred to herein as the “focused distance”. The laser light is reflected off a target surface such as a barcode 272, and reflected light is collected by the light collecting system.

Scanning the collection optic provides a large aperture light collection system. The dynamic range of the light collection system is fairly large because it can collect a large amount of light at a far distance; however, this alone does not guarantee being able to read a barcode from a far distance. This is because even though the outgoing laser beam is collimated, it still has a beam waist. When the outgoing laser beam is focused close-in, the waist radius is smaller, but further out from the beam waist, the beam diverges quickly. When the output laser beam is focused far-out, the waist radius is larger, but the divergence angle is shallower. Large dynamic range (being able to read close and far) is desirable, as is being able to read fine barcodes (good resolution). Reading fine barcodes requires that the laser beam have a spot size smaller than the barcode pitch. The term “spot size” refers to the size of the laser beam diameter at any given distance “Z”. The smallest spot size occurs at the beam waist.

To achieve the dynamic range, a small spot size is desirable at close distance (e.g., 100 mm), and a small spot size is also desirable at far distance (e.g., 1 m). Because of the beam waist issue, focusing the beam such that the spot is small at close distance causes the spot to be significantly larger at far distance. Likewise, focusing out at far distance causes the spot to be large at close distance.

Various embodiments of the present invention achieve the dynamic range through the use of the variable laser focus mechanism. While the scanning platform is scanning back and forth, the variable focus mechanism sweeps the beam waist in and out to determine the proper focused distance based on the current reflection distance. For example, the beam waist may be initially focused at a reflection distance of 100 mm. On successive scans, the beam waist may be focused further out (e.g., to 200 mm, then 300 mm, etc). This may be repeated such that the focused distance is swept in and out as the scanning platform scans. In some embodiments, the focused distance (and therefore the location of the beam waist) is swept slower than the scanning. For example, in some embodiments, the scan may be performed at 60 Hz, while the focus may be swept out and back at 5 Hz or 10 Hz.

In some embodiments, the focus is continually swept as a barcode is read. In other embodiments, the beam waist is swept out and back to detect the best return signal. Once the best return signal is found, the focus is fine tuned and dwells at the proper distance. Various embodiments capable of sweeping and dwelling are described further below with reference to later figures.

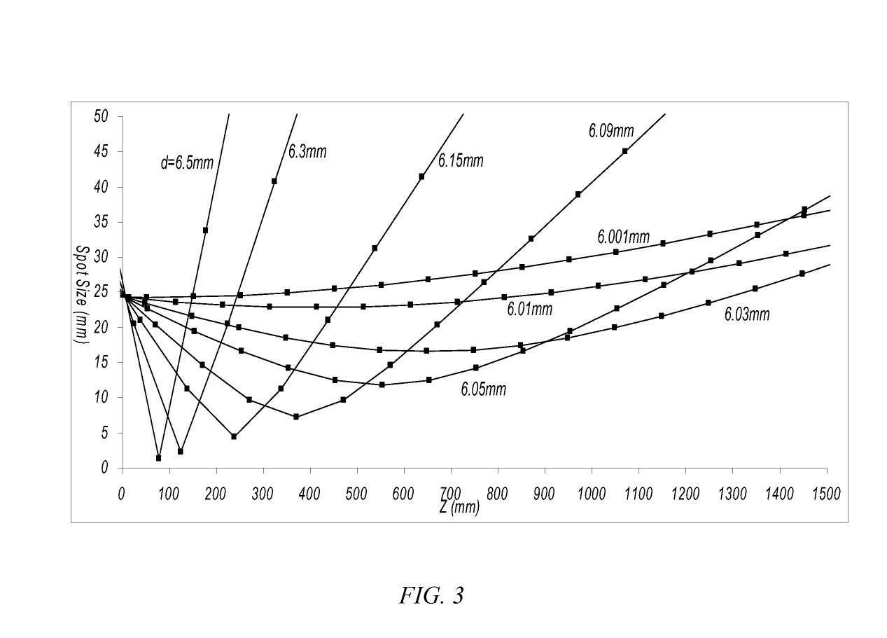

FIG. 3 shows laser spot size as a function of distance and variable focus. The laser spot size plots of FIG. 3 are parameterized using eight different distances “d” between the light source and the focusing lens (e.g., between light source 140 and lens 142). The eight different distances vary between 6.001 mm and 6.5 mm in a system with a focal length of 6.0 mm. Each curve shows the diameter of the laser spot “spot size” as a function of reflection distance “Z”.

The plots shown in FIG. 3 demonstrate the tradeoff between dynamic range and spot size for any given focused distance. For example, the beam waist can be focused at about 80 mm by setting the distance between the laser light source and focusing lens at 6.5 mm. The spot size at the beam waist (Z=80 mm) is approximately 2 mm, but the spot gets very large (>25 mm) out at Z=150 mm. This demonstrates the fast beam divergence when focused close-in. In this example, the variable focus mechanism can be set with the laser light source at 6.5 mm from the collimation lens allowing barcodes with very fine pitch to be read, but only very close-in.

In another example, the beam waist can be focused at about 375 mm by setting the distance between the laser light source and the focusing lens to 6.09 mm. This decreased distance between the laser light source and the lens produces a larger beam waist further out, and the beam diverges more slowly. The spot size at 375 mm is approximately 7 mm.

Sweeping the variable focus mechanism continuously moves between the curves in FIG. 3. When a return signal is detected, the sweep stops and the variable focus mechanism is set to dwell at the focused distance providing the strongest signal. Without the variable focus mechanism, a barcode reader could read fine barcodes over small distance ranges or large barcodes over larger distance ranges, but not fine barcodes over large distance ranges. The various embodiments of the present invention allow small barcodes to be read over large distance ranges (large dynamic range).

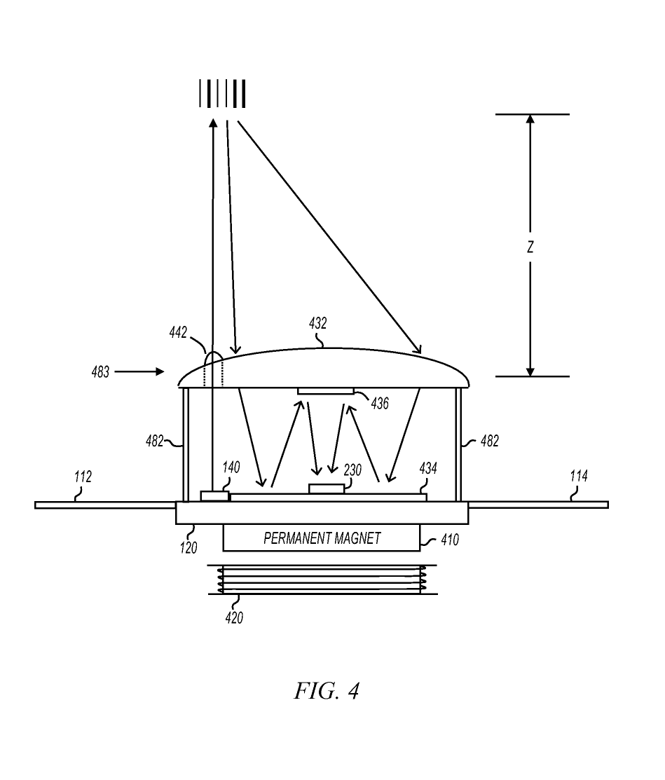

FIG. 4 shows a cross section of a light scanning and collection device with an integrated optical lens and variable laser focus. Scanning platform 120 is shown coupled to flexible members 112, 114. Laser light source 140, photodiode 230, and mirror 434 are shown coupled to scanning platform 120. Lens assembly 483 is also shown coupled to scanning platform by supports 482. Permanent magnet 410 is shown coupled to the underside of scanning platform 120, and electromagnet 420 is shown beneath scanning platform 120.

Electromagnet 420 and permanent magnet 410 form an actuation mechanism. In operation, electromagnet 420 is energized periodically to produce an oscillation of scanning platform 120. Embodiments having a permanent magnet mounted to the scanning platform are referred to as a “moving magnet design.” In some embodiments, an electromagnet is affixed to scanning platform 120, and a permanent magnet is provided beneath scanning platform 120. Embodiments having an electromagnet (coil) mounted to the scanning platform are referred to as a “moving coil design.” Other types of actuation may be provided.

Lens assembly 483 includes a focusing lens 442 formed within a transmissive collection optic 432. Lens assembly 483 also includes a mirror 436 affixed to the underside, forming a folded telescope arrangement with mirror 434. Mirror 434 is annular about photodiode 230. The distance between lens assembly 483 and scanning platform 120 affects the moment of inertia of the scanning assembly, and may be modified during the design process by varying the characteristics of the folded telescope.

In operation, laser light source 140 produces a laser beam that is focused by focusing lens 442. The laser beam reflects off a surface and then light is collected by transmissive collection optic 432. Collected light is reflected by mirrors 434 and 436, and is then incident on photodiode 230.

Scanning platform 120 includes a variable focus mechanism in the plane of the platform beneath laser light source 140. Examples of such variable focus mechanisms are described further below with reference to later figures. In operation, the variable focus mechanism is used to move laser light source 140 in a direction having a component orthogonal to the plane of scanning platform 120 and towards and away from focusing lens 442. In some embodiments, an electromagnetic actuation mechanism (moving coil design or moving magnet design) may be utilized to effect the movement of the variable focus mechanism. As shown in FIG. 3, for a focal length of 6 mm, laser light source movements of a fraction of a millimeter will provide significant changes in focus and beam waist location.

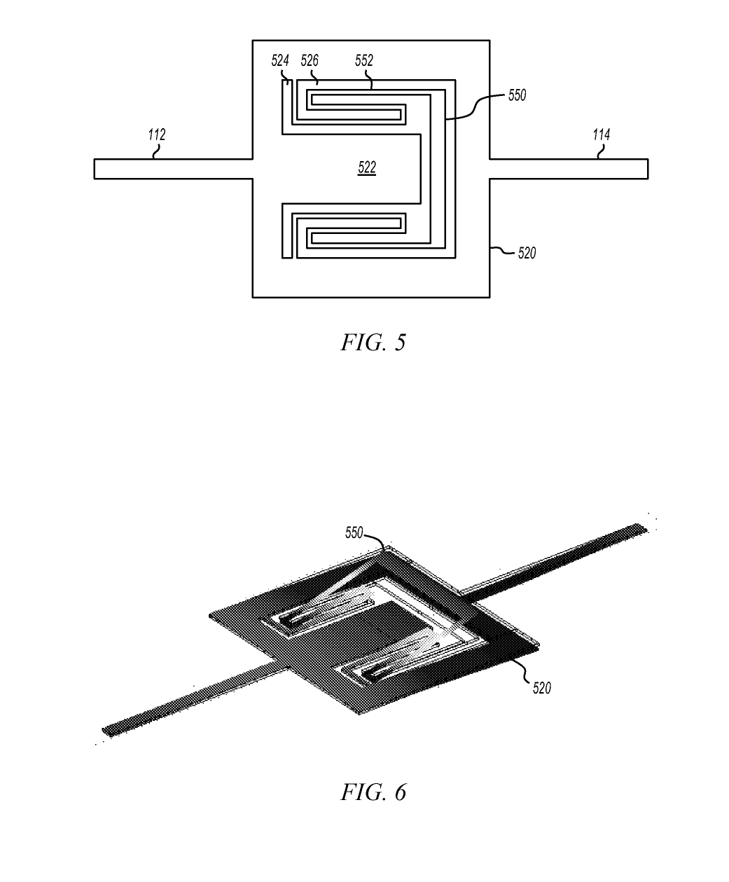

FIG. 5 shows a top view of a scanning platform with a plunging device useful for variable laser focus. Scanning platform 520 is coupled to flexible members 112 and 114. The flexible members operate as described above. Scanning platform 520 also includes two cut-out areas 524 and 526 leaving serpentine flexures 552 and plunging arm 550. Plunging arm 550 forms a flexible appendage of scanning platform 520. In some embodiments, all of scanning platform 520 is made of a polymer material such as FR4.

In some embodiments, a moving coil design is provided in which a metal (current carrying) trace traverses the serpentine flexures 552 and plunging arm 550. In these embodiments, a permanent magnet may be coupled to scanning platform 520. In other embodiments, a moving magnet design is provided in which a magnet is affixed to plunging arm 550 and an electromagnet is provided elsewhere. Other actuation mechanisms may be utilized without departing from the scope of the present invention.

Scanning platform 520 includes substantially planar face 522. When actuated, plunging arm 550 moves in a slight arc with the main component of movement being orthogonal to planar face 522. The subtended arc may be modified by changing one or more of many design parameters, including for example, the length of serpentine flexures 552, the focal length of the focusing lens, the desired dynamic range, etc.

A laser light source may be mounted to plunging arm 550. When the plunging arm is actuated, the distance between the laser light source and the focusing lens can be modified, thereby changing the focus of the outgoing laser beam.

FIG. 6 shows a perspective view of the scanning platform of FIG. 5. Plunging arm 550 is shown “actuated” out of the plane of scanning platform 520. The movement is greatly exaggerated in FIG. 6 so as to show the direction of movement. In an actual system, the movement of plunging arm is very slight (on the order of a fraction of a millimeter).

The variable focus mechanism can be designed with a particular mechanical resonant frequency. In some embodiments, a mechanical resonant frequency of about 110 Hz is used. This works well when the plunging arm is swept in and out at about 5 Hz. Any combination of resonant frequencies and sweep rates may be used without departing from the scope of the present invention.

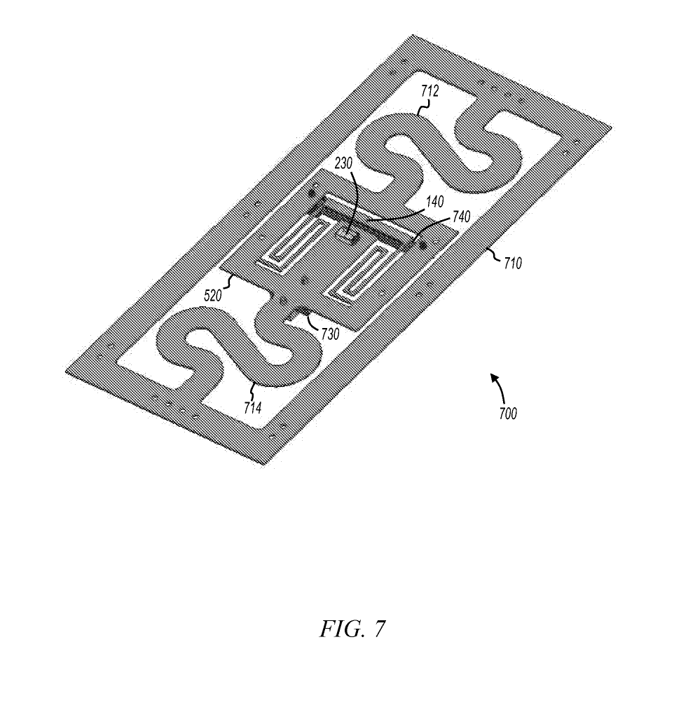

FIGS. 7-9 show imaging devices at various levels of integration. Referring to FIG. 7, device 700 includes scanning platform 520 coupled to fixed platform 710 by flexible members 712 and 714. Scanning platform 520 is also shown in FIG. 5. In the example of FIG. 7, flexible members 712 and 714 are “S” shaped.

Permanent magnet 740 is affixed to the underside of scanning platform 520, and a metal trace is run across the plunging arm, thereby providing a moving coil design. In some embodiments, the metal trace is run from one end of fixed platform 710, across one of the flexible members 712, 714, across the serpentine flexures and plunging arm, and then across the other flexible member. When an electrical current is provided through the metal trace, a B-field is produced in the plane of scanning platform 520, but perpendicular to the plunging arm. The permanent magnet 740 also generates a B-field perpendicular to the plunging arm. The Lorentz force developed is proportional to the length of the plunging arm times the amplitude of the current times the amplitude of the B-field from magnet 740. The direction of the force vector is in or out of plane depending on the sign of the current. The metal trace that forms the coil may include multiple traces on one or more metal layers within the polymer material forming scanning platform 520.

An alternating current (AC) will cause the plunging arm to sweep in and out. For example, a current alternating at 5 Hz will cause the plunging arm to sweep in and out at 5 Hz. The magnitude of the current determines the displacement of the plunging arm. A laser light source 140 is placed on the plunging arm. When the plunging arm is displaced, variable focus is achieved. When the desired focus is determined, a direct current can be applied, thereby causing the plunging arm to have a constant displacement, resulting in a constant focus. Photodiode 230 is shown affixed to the planar section of the scanning platform. Photodiode 230 collects reflected light.

Permanent magnet 730 is shown affixed to the underside of scanning platform 520. Magnet 730 interacts with a coil (not shown) to form a moving magnet design for actuating the movement of scanning platform 520.

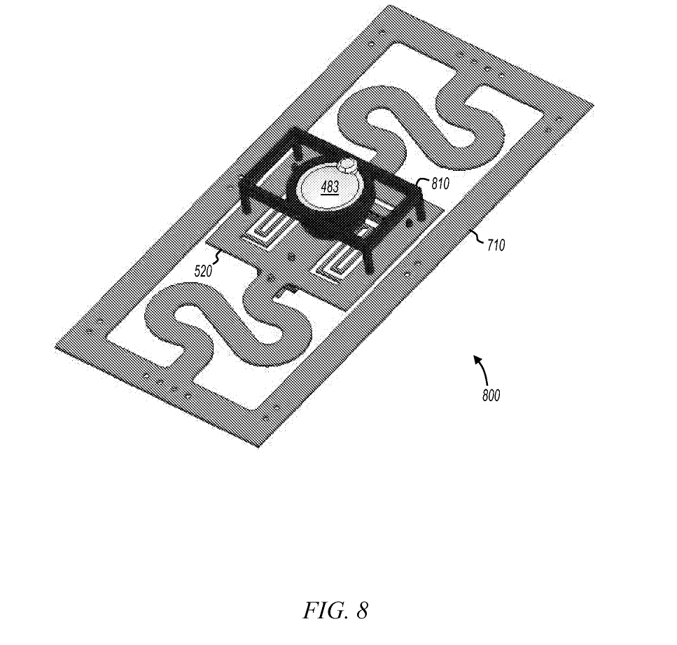

Referring now to FIG. 8, device 800 includes device 700 (FIG. 7, optics frame 810, and lens assembly 483. Lens assembly 483 is described above with reference to FIG. 4. Lens assembly 483 includes a focusing lens aligned with the laser light source, and a collection optic aligned with the photodiode. Optics frame 810 holds lens assembly 483 and is affixed to scanning platform 520.

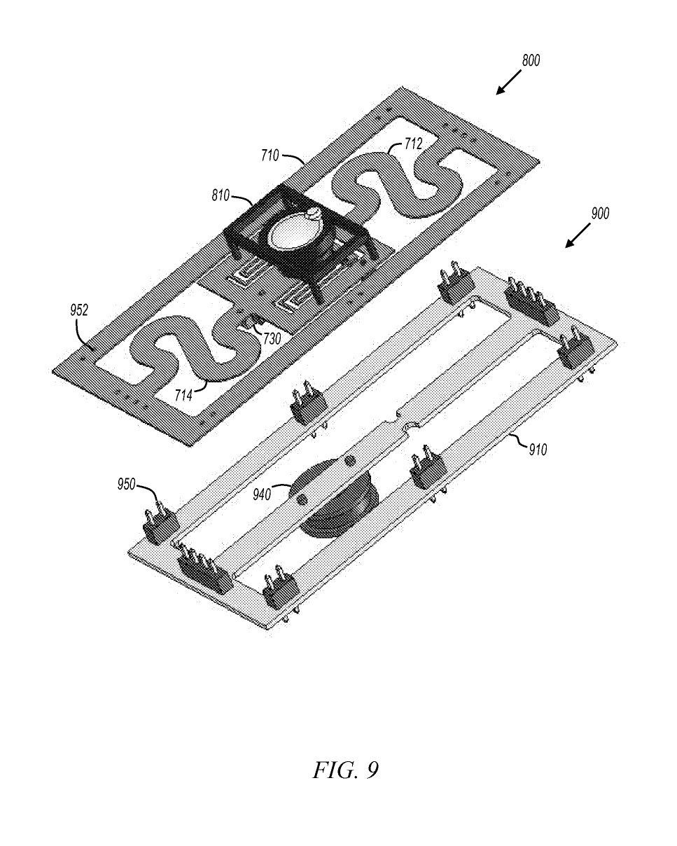

Referring now to FIG. 9, device 800 is shown in an exploded view with device 900. Device 900 includes frame 910 having coil 940 and connectors 950 attached. In some embodiments, device 900 is made from the same material as fixed frame 710, but this is not a limitation of the present invention.

When devices 800 and 900 are mated, connectors 950 mate with plated holes 952. Permanent magnet 730 and coil 940 form a moving magnet design actuation system operable to cause scanning platform 520 to oscillate. Device 900 may include metal traces leading to and from coil 940. When current is run in the metal traces, coil 940 is energized, thereby producing a B-field. In some embodiments, coil 940 is driven at the same frequency as the mechanical resonant frequency of the scanning assembly. For example, if the scanning assembly is designed to have a 60 Hz mechanical resonant frequency, then coil 940 may be driven at substantially 60 Hz.

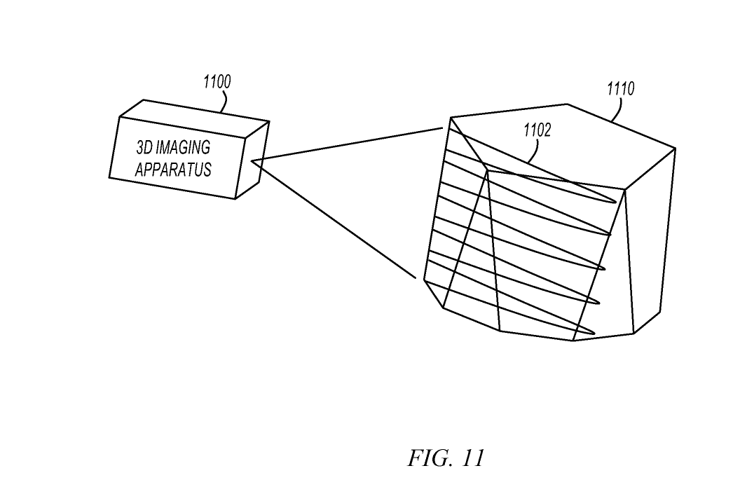

The devices shown in FIGS. 7-9 are referred to as “imaging systems” because their use is not limited to barcode reading. The various embodiments of the present invention can be advantageously employed in any application that can benefit from variable laser focus. Barcode reading is but one example. Another example is 3D imaging, discussed further below with reference to FIG. 11.

FIG. 7-9 show a particular physical structure capable of supporting a polymer scanning platform having an integrated variable focus light emitting system and an integrated light collection system. The various embodiments of the present invention are not limited to the structure shown. Those skilled in the art will recognize the multitude of equivalent structures capable of supporting a variable focus laser system.

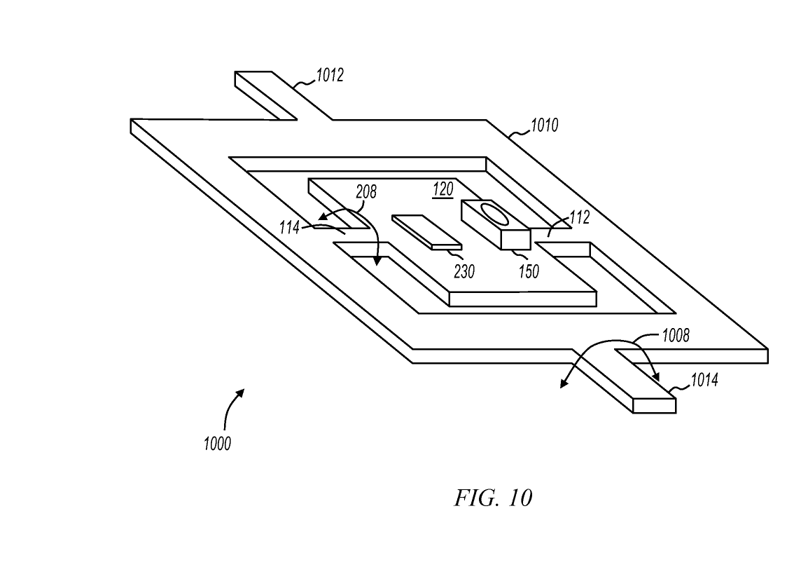

FIG. 10 shows a biaxial polymer scanning platform. Scanning platform 120 is coupled to frame 1010 by flexible members 112 and 114, allowing scanning platform 120 to pivot as shown by arrow 208. Photodiode 230 and variable focus mechanism 150 are coupled to scanning platform 120. The operation of photodiode 230, variable focus mechanism 150, and flexible members 112 and 114 is described above.

Frame 1010 is a moving frame. Frame 1010 is coupled to a fixed frame (not shown) by flexible members 1012 and 1014, allowing frame 1010 to pivot as shown by arrow 1008. When the pivoting motion of flexible members 112, 114, 1012, and 1014 are combined, scanning platform 120 operates as a “biaxial” scanner capable of scanning a light beam in two dimensions. Magnetic actuation mechanisms for each of the two dimensions may be moving magnet or moving coil designs. Other actuation mechanisms may also be used.

In some embodiments, a biaxial scanner is formed by coupling scanning platform 120 to a fixed frame by a single flexible member, or “flexure”, and driving an actuation mechanism to elicit movement in two dimensions. Various “single flexure” embodiments are further described in parent application Ser. No. 11/704,695.

FIG. 11 shows the operation of a three dimensional imaging device. Three dimensional (3D) imaging apparatus 1100 includes a biaxial scanning platform with variable laser focus. The 3D imaging apparatus scans a laser beam across 3D object 1100. A sample scan pattern is shown at 1102.

3D imaging apparatus 1100 is able to image a 3D object by determining the reflection distance at various points in the scan trajectory. For example, as the biaxial scanner scans the laser beam over the 3D surface, the variable focus mechanism sweeps the beam waist in and out. The light collection system collects the reflected light. The distance to the 3D surface is determined by the return signal.

3D imaging apparatus may take any form, and any type of object may be imaged. For example, in some embodiments, 3D imaging apparatus is part of a medical device such as an endoscope, and the object being imaged is living tissue. Also for example, in some embodiments, 3D imaging apparatus may be part of an archeological tool, and the object being imaged is non-living tissue.

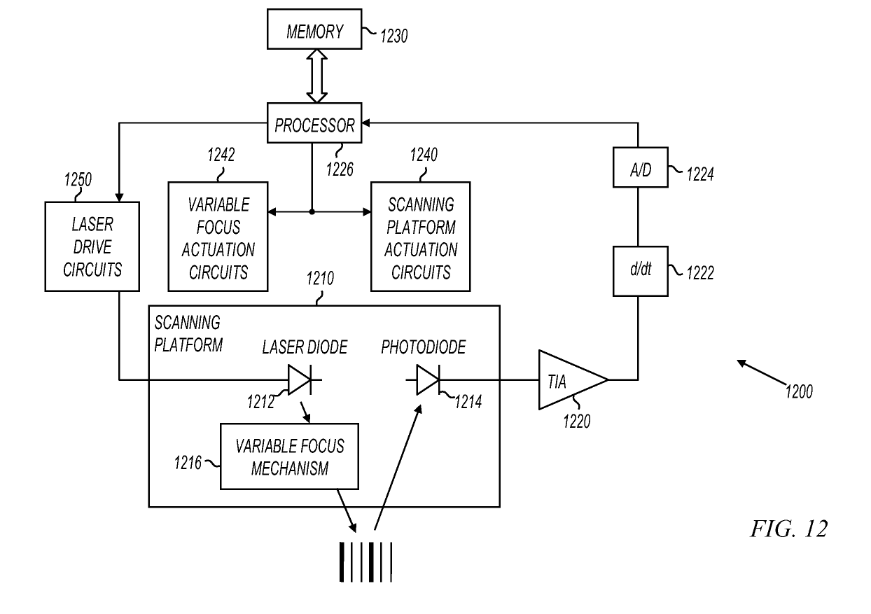

FIG. 12 shows a diagram of a barcode scanning apparatus. Apparatus 1200 includes scanning platform 1210, laser diode 1212, photodiode 1214, transimpedance amplifier (TIA) 1220, differentiator 1222, analog-to-digital (A/D) converter 1224, processor 1226, memory 1230, laser drive circuits 1250, scanning platform actuation circuits 1240, and variable focus actuation circuits 1242.

Scanning platform 1210 may be any scanning platform embodiment described herein. For example, scanning platform 1210 may be scanning platform 120, and may include reflective and/or transmissive optics. Also for example, scanning platform 1210 may be scanning platform 520, and may include an integrated optical lens assembly. Scanning platform 1210 is shown having laser diode 1212, variable focus mechanism 1216, and photodiode 1214. Laser diode 1212 is driven by laser drive circuits 1250. Laser drive circuits 1250 provide the current drive necessary to cause laser diode 1212 to produce laser light.

Variable focus mechanism 1216 may be any variable focus mechanism described herein. For example, variable focus mechanism 1216 may be variable focus mechanism 150. Also for example, variable focus mechanism 1216 may be formed from a plunging device such as those shown and described with reference to FIGS. 4-9. Variable focus mechanism 1216 is actuated by variable focus actuation circuits 1242. Variable focus actuation circuits 1242 can provide AC or DC actuation to cause the variable focus mechanism to sweep the focus or to dwell at a specific focus value. In magnetic actuation embodiments, variable focus actuation circuits 1242 provide current to coils or metal traces in moving coil designs or moving magnet designs.

Photodiode 1214 receives reflected laser light, and provides a current representing the received light power. The current from the photodiode is provided to TIA 1220, which converts the current to a voltage. TIA 1220 drives a differentiator 1222, which detects changes in received light power as the laser beam is scanned. A/D 1224 converts the output of differentiator 1222 to a digital representation, and provides it to processor 1226. This signal is referred to as the “return signal.” A strong return signal corresponds to a well focused laser beam.

Processor 1226 represents any type processing apparatus. For example, processor 1226 may be a microprocessor, digital signal processor (DSP), microcontroller, or the like. Also for example, processor 1226 may be a dedicated hardware circuit, such as a state machine. Memory 1230 is coupled to processor 1226. Memory 1230 may be any type of apparatus capable of storing information. For example, memory 1230 may be volatile memory such as static random access memory (SRAM) or dynamic random access memory (DRAM). Also for example, memory 1230 may be nonvolatile memory such as “Flash” memory. Still further, memory 1230 may be a computer readable medium that is encoded with instructions to be executed by processor 1226. Examples of computer-readable media include, but are not limited to, floppy disks, hard disks, CD-ROM, or any other suitable storage device.

Scanning platform actuation circuits 1240 provide excitation to scanning platform 1210 to cause mechanical oscillation. Oscillation may occur in one or more dimensions. Actuation circuits 1240 and 1242 may include any type of circuits capable of producing the mechanical forces, including magnetic, thermal, and electrostatic circuits.

Imaging apparatus 1200 may be handheld or stationary. In addition, imaging apparatus 1200 may include many other components. For example, imaging apparatus 1200 may include a display, a “trigger” device to enable a user to initiate scanning, data communications ports, radio frequency (RF) transceivers such as Bluetooth or Ultra Wideband (UWB), speakers, haptic feedback devices, or the like.

In operation, scanning platform 1210 scans in one or two dimensions causing a laser light beam to scan across a surface. At the same time, variable focus mechanism 1216 sweeps the focus of the outbound laser beam in and out. In some embodiments, the focus is swept at a rate slower than the scan, although this is not a limitation of the present invention. For example, the scan may be at 60 Hz and the focus sweep may be at 5 Hz.

When a strong return signal is detected by processor 1226, the current focus distance represents the reflection distance. Armed with this information, processor 1226 is able to determine the reflection distance (the distance from the imaging device to the reflecting surface). Processor 1226 is then able to command variable focus actuation circuits 1242 to dwell the focus at the reflection distance if desired. For example, in barcode reading applications, the entire barcode is at substantially the same reflection distance, so setting the variable focus to dwell at a particular distance may be desirable. Also for example, in 3D imaging applications, the current reflection distance may be logged as one point in a 3D image, and the sweep of the variable focus mechanism may continue.

The various embodiments of the invention as described represent a highly integrated system that combines mechanical (static and dynamic), electrical, and optical systems into one assembly. A single scanning assembly can include a laser light source, variable laser focus, a photodetector, associated optics, and electronic components. The size, weight, and location of components can be modified, all of which can affect the moment of inertia. Components can also be mounted varying distances away from the scanning platform to affect the moment of inertia. For example, lenses can be mounted at varying heights above the pivot axis of the scanning platform. The thickness of the polymer substrate can also be varied. All of the variables available to the designer may be manipulated to arrive at an optical system with increased range as well as a mechanical system with the desired resonant qualities for a scanning light emitting and collection system.

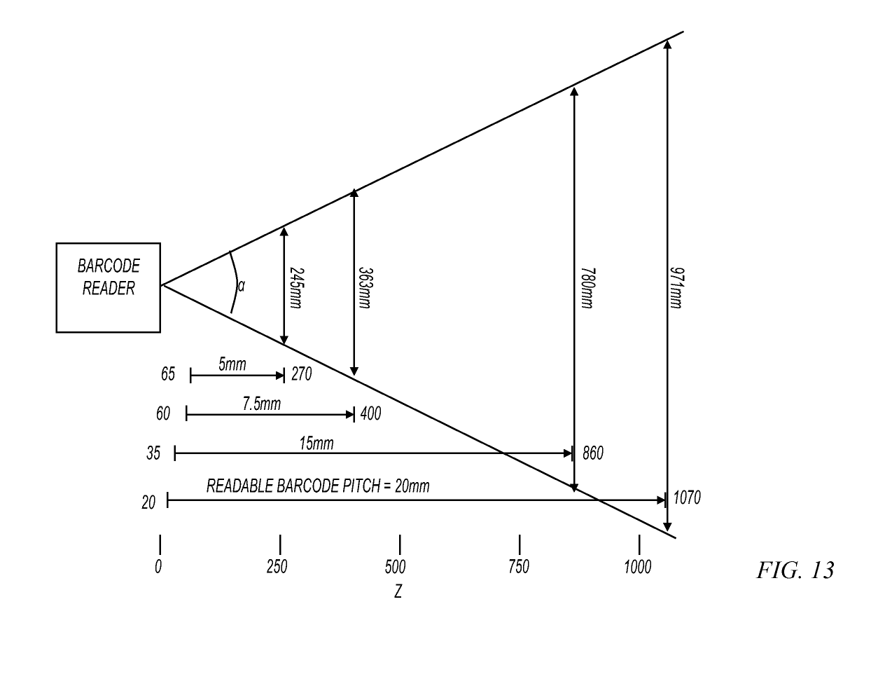

FIG. 13 shows barcode scanner operation with variable focus and a fixed scan angle. The numbers shown in FIG. 13 correspond to a scan angle α of 52 degrees. Other scan angles may be used. As shown in FIG. 13, a barcode with a 5 mm pitch can be read from a reflection distance Z of between about 65 mm and 270 mm; and a barcode with a 20 mm pitch can be read from a reflection distance Z of about 20 mm to about 1.07 m. Similar data is given for barcode pitches of 7.5 mm and 15 mm. This data corresponds to that shown in FIG. 3.

FIG. 13 also shows the distance that the laser beam sweeps at a given reflection distance for a 52 degree scan angle. For example, at Z=270 mm, the beam sweeps 245 mm. Also for example, at 1.07 m, the beam sweeps 971 mm. When a barcode is at a close reflection distance, a larger scan angle is needed because the angle subtended by the barcode is large when you are close-in. However, this is not necessarily true for large reflection distances. For large reflection distances, the light is missing the barcode most of the time.

Various embodiments of the present invention modify the scan angle as a function of the reflection distance. For example, the variable focus mechanism and return signal provide information from which the reflection distance can be derived. Knowing the distance to the barcode, the scan angle can be collapsed to optimize the scan angle as a function of the distance. More of the outgoing energy is focused on the barcode this way, and less energy is wasted.

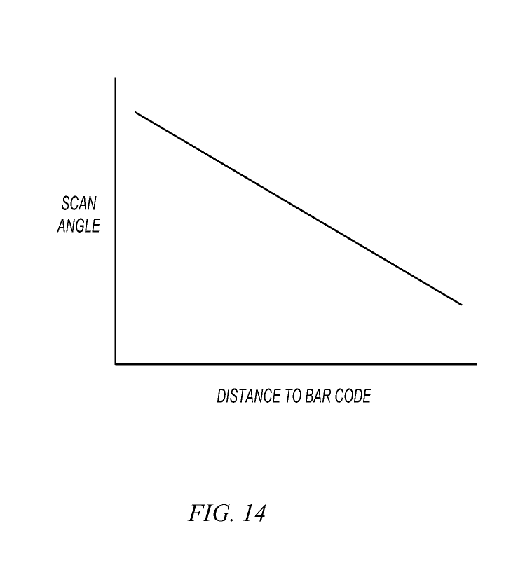

FIG. 14 shows a graph of barcode scanner operation with a variable scan angle. As shown in FIG. 14, the scan angle is reduced for greater reflection distances. A barcode scanner (or any imaging embodiment with variable focus) can modify the scan angle based on reflection distance as determined by the operation of the variable focus mechanism and the return signal.

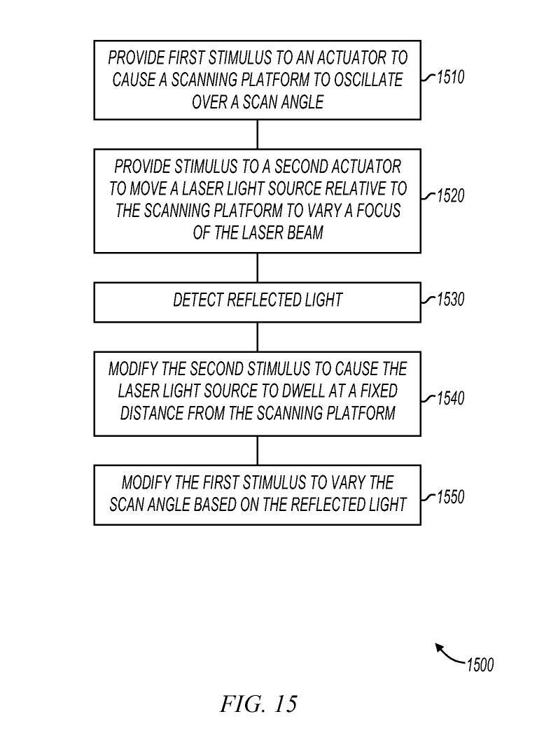

FIG. 15 shows a flow chart in accordance with various embodiments of the present invention. In some embodiments, method 1500, or portions thereof, is performed by a barcode reader, an imaging apparatus, or the like, embodiments of which are shown in previous figures. In other embodiments, method 1500 is performed by an integrated circuit or an electronic system. Method 1500 is not limited by the particular type of apparatus performing the method. The various actions in method 1500 may be performed in the order presented, or may be performed in a different order. Further, in some embodiments, some actions listed in FIG. 15 are omitted from method 1500.

At 1510, a first stimulus is provided to a first actuator to cause a scanning platform to oscillate over a scan angle. This corresponds to processor 1226 providing stimulus to actuation circuits 1240 to cause scanning platform 1210 to oscillate (FIG. 12). The resulting scan angle is a function of the amplitude of the stimulus. In some embodiments, the stimulus is in the form of digital commands from the processor. In other embodiments, the stimulus is in the form of a current to be driven through a coil. In still further embodiments, the thermal or electrostatic stimulus is provided. The stimulus may cause the scanning platform to oscillate a mechanical resonant frequency, but this is not a limitation of the present invention.

At 1520, a second stimulus is provided to a second actuator to move a laser light source relative to the scanning platform to vary a focus of the laser beam. This corresponds to processor 1226 providing stimulus to actuation circuits 1242 to cause variable focus mechanism 1216 to sweep the beam waist in and out. At 1530, reflected light is detected. The light may have been reflected from any surface. For example, in barcode reader embodiments, the light may have been reflected off a surface having a barcode. Also for example, in imaging embodiments, the light may have been reflected off an object being imaged.

In response to the reflected light, a return signal is constructed as shown in FIG. 12. A strong return signal corresponds to the focused distance being substantially equal to the reflection distance. In some embodiments, method 1500 stops here. For example, in imaging embodiments, the goal is to determine the reflection distance at various points in the scan.

At 1540, the second stimulus is modified to cause the laser light source to dwell at a fixed distance from the scanning platform. The second stimulus is modified in response to the return signal. For example, the second stimulus may have been initially set at 1520 to cause the variable focus mechanism to continually sweep in and out. When a strong return signal is detected, the second stimulus may be modified to cause the variable focus mechanism to dwell at the focused distance that resulted in the strongest return signal. In some embodiments, an adaptive search algorithm is employed in which the sweep of the variable focus is first narrowed, and then the best return signal is “hunted”. The actions of 1540 may be useful when it is advantageous to dwell the focus at a particular distance. Barcode reading is one application in which the actions of 1540 may be useful.

At 1550, the first stimulus is modified to vary the scan angle based on the reflected light. If the reflection distance is determined to be large, the first stimulus may be modified to collapse the scan angle to save energy. This may be useful in many different applications, including barcode reading and 3D imaging.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

What is claimed is:

1. An apparatus comprising:
a scanning platform operable to have a variable angular displacement;
an optical lens affixed to the scanning platform;
a laser light source aligned with the optical lens; and
a plunging device to which the laser light source is affixed, the plunging device being operable to move with respect to the scanning platform to change a distance between the laser light source and the optical lens.

2. The apparatus of claim 1 further comprising a fixed frame and at least one flexible member coupling the scanning platform to the fixed frame.

3. The apparatus of claim 1 further comprising a magnet affixed to the scanning platform, and wherein the plunging device includes at least one conductor capable of carrying a current that results in a Lorentz Force on the plunging device.

4. The apparatus of claim 1 further comprising magnet affixed to the plunging device, and wherein the scanning platform includes at least one conductor capable of carrying a current that results in a Lorentz Force on the plunging device.

5. The apparatus of claim 1 wherein the scanning platform includes at least one cut-out area, and the plunging device is formed by material separated from the scanning platform by the at least one cut-out area.

6. The apparatus of claim 1 wherein the plunging device comprises a flexible piece of material coupled to the scanning platform.

7. The apparatus of claim 1 wherein the scanning platform and the plunging device are formed from a polymer.

8. The apparatus of claim 7 wherein the polymer comprises a glass-epoxy material.

9. An apparatus comprising:
a laser light source;
an optical device to focus laser light from the laser light source;
a scanning platform having a substantially planar surface to which the optical device is affixed; and
a variable focus mechanism to which the laser light source is affixed, the variable focus mechanism operable to translate the laser light source in a direction having a component perpendicular to the substantially planar surface of the platform.

10. The apparatus of claim 9 wherein the variable focus mechanism includes an appendage of the scanning platform made of a polymer material.

11. The apparatus of claim 9 wherein the variable focus mechanism is magnetically actuated.

12. The apparatus of claim 9 further comprising at least one flexible member coupled to the scanning platform, to provide a pivot axis upon which the scanning platform can pivot.

13. The apparatus of claim 9 further comprising a photodiode coupled to the scanning platform.

14. The apparatus of claim 13 further comprising a second lens to focus reflected laser light onto the photodiode.

15. The apparatus of claim 9 wherein the scanning platform is operable to scan in two dimensions.

16. An imaging method comprising:
scanning a laser light beam in at least one dimension; and
moving a laser light source with respect to a focusing lens to modify a beam waist location of the laser light beam.

17. The imaging method of claim 16 further comprising:
receiving reflected light at a light sensitive electronic component; and
producing an electrical signal that represents the reflected light.

18. The imaging method of claim 17 further comprising setting the laser light source to dwell at a fixed distance from the focusing lens based at least in part on the electrical signal that represents the reflected light.

19. The imaging method of claim 17 further comprising modifying a scan angle through which the laser light beam is scanned based at least in part on the electrical signal that represents the reflected light.

20. The imaging method of claim 16 wherein scanning a laser light beam in at least one dimension comprises scanning the laser light beam in two dimensions while modifying the beam waist location to image a three dimensional object.

21. A method comprising:
scanning a laser light beam over a scan angle;
receiving reflected light from a barcode; and
modifying the scan angle in response to the reflected light.

22. The method of claim 21 further comprising sweeping a laser light source towards and away from a lens to change a beam waist location of the laser light beam while scanning.

23. The method of claim 22 further comprising stopping the sweeping at a fixed focus value in response to the reflected light.

24. The method of claim 22 wherein the scanning is performed faster than the sweeping.

25. A computer-readable medium having instructions stored thereon that when accessed result in a computer performing:
providing first stimulus to a first actuator to cause a scanning platform to oscillate over a first scan angle;
providing second stimulus to a second actuator to move a laser light source relative to the scanning platform to vary an output focus of a laser beam;
detecting reflected laser light; and
modifying the second stimulus to cause the laser light source to dwell at a substantially fixed distance from the scanning platform.

26. The computer readable medium of claim 25 wherein detecting reflected laser light comprises determining a distance between the laser light source and a reflective surface.

27. The computer readable medium of claim 26 wherein the instructions, when accessed, further result in the computer modifying the first stimulus to change the first scan angle based on the distance between the laser light source and the reflective surface.
